(19) United States
(12) Patent Application Publication
(10) Pub. No.: US 2009/0033192 A1
(43) Pub. Date: Feb. 5, 2009

(54) Electric lamp with an outer bulb and an integral lamp arranged in the outer bulb

(75) Inventor: Andreas Nittke, Pietenfeld (DE)

Correspondence Address: OSRAM SYLVANIA INC, 100 ENDICOTT STREET, DANVERS, MA, 01923, US

(73) Assignee: OSRAM GESELLSCHAFT MIT BESCHRANKTER BESCHRANKTER HAFTUNG, MUNCHEN (DE)

(21) Appl. No.: 12/213,320

(22) Filed: Jun. 18, 2008

(30) Foreign Application Priority Data
Jul. 30, 2007 (DE) 10 2007 035 597.3

(51) Int. Cl. H01K 1/42

(52) U.S. Cl. 313/25

(57) ABSTRACT

An electric lamp (1) has a base at one end and with an outer bulb (3), mounted in a base (2), and at least one integral lamp (4), preferably a high-voltage halogen lamp, which is arranged within the outer bulb (3), and at least two power supply wires (15) from the base (2) to the integral lamp (4). The at least two power supply wires (15) are surrounded by a preferably cylindrical bulb (5), formed from a nonconductive light-permeable material, preferably identical to the material used for the outer bulb (3), in particular glass, and the preferably cylindrical bulb (5) is in the form of a holding apparatus for the integral lamp (4).

### TECHNICAL FIELD

The invention relates to an electric lamp with a base at one end and with an outer bulb, mounted in a base, and at least one integral lamp, preferably a high-voltage halogen lamp, which is arranged within the outer bulb, and at least two power supply wires from the base to the integral lamp.

### PRIOR ART

As a result of their long life and pleasant light quality, halogen incandescent lamps are increasingly preferred to conventional incandescent lamps. In order to make it possible to replace existing incandescent lamps with halogen incandescent lamps as simply as possible and at the same time to maintain the visual appearance of a conventional incandescent lamp for aesthetic or functional reasons, lamps are often used in which the outer contour and therefore in particular the outer bulb and the base correspond to a conventional incandescent lamp, while a halogen incandescent lamp is arranged as an integral lamp within the outer bulb. Such lamps are produced and marketed, for example, by OSRAM GmbH under the designation “HALOLUX® CLASSIC”.

In order to bring the outward appearance and the luminous properties of such a lamp close to those of a conventional incandescent lamp, the incandescent wire of the integral lamp needs to be arranged approximately at the same point as the incandescent wire of a comparable conventional incandescent lamp. For this purpose, the substantially more compact halogen lamp needs to be positioned in the outer bulb by means of a holder.

It is known from EP 0 498 256 to fix the integral lamp directly to the power supply wires and therefore to use these power supply wires as the holder. However, this is only possible with relatively short power supply wires since otherwise the lamp will be extremely sensitive to vibrations and the live power supply wires will be exposed in the event of breakage of the outer bulb.

A technology used in the abovementioned “HALOLUX® CLASSIC” lamps for positioning the integral lamp consists in providing a vitreous plate-like stand, which is fused into the outer bulb. The plate-like stand bears a frame manufactured from metal, by means of which the halogen integral lamp is in turn held. Furthermore, power supply wires are fused into the plate-like stand, and the power supply lines of the integral lamp are welded to said power supply wires. This design requires, in order to pass the power supply wires through the vitreous plate-like stand, a three-part design of the power supply wires and is generally very complex as a result of the combination of metallic and vitreous components.

DE 10 2005 051 076 has disclosed a holder for the integral lamp, which holder comprises a metallic mounting clip, into which the integral lamp is inserted. The mounting clip is fitted on the vitreous plate-like stand of the outer bulb, which is very involved, however, since the vitreous stand represents a very complex component which comprises, for example, an exhaust tube and fused-in power supply wires. In addition, when using a metallic mounting clip there is the risk of damage to the outer bulb during fitting or operation of the lamp and it is necessary to ensure that no live parts come into contact with the clip. Furthermore, the metallic holder is visually very obvious and considerably disrupts the transparent outward appearance known from a conventional incandescent lamp.

### DESCRIPTION OF THE INVENTION

The invention is therefore based on the object of providing an electric lamp with a base at one end and with an outer bulb, mounted in a base, and at least one integral lamp, preferably a high-voltage halogen lamp, which is arranged within the outer bulb, and at least two power supply wires from the base to the integral lamp, which is robust and can be produced in a simple manner and in which the power supply wires are reliably protected against the risk of electric shock by touching contact in the event of breakage of the outer bulb.

With respect to the lamp, the object is achieved according to the invention by virtue of the fact that the at least two power supply wires are surrounded by a preferably cylindrical bulb, formed from a nonconductive light-permeable material, preferably identical to the material used for the outer bulb, in particular glass, and the preferably cylindrical bulb is in the form of a holding apparatus for the integral lamp. A light-permeable material impairs the emission of the light emitted by the integral lamp only slightly and is visually unobvious, with the result that the appearance of the lamp is similar to that of conventional incandescent lamps including that of known lamps with a halogen integral lamp. Faults, such as damage to the power supply wires or the integral lamp, for example, can still easily be identified with a transparent material even once the lamp is finished. As a result of the simple geometry, a cylindrical bulb can be produced with substantially less complexity than, for example, a plate-like stand and, as a result of the use of a nonconductive material, provide good protection against touching contact for the power supply wires. If the material of the preferably cylindrical bulb is identical to that used for the outer bulb, both the visual impression and the mechanical and electrical properties are identical, which is of particular advantage in the case of a connection between the two bulbs. Since the bulb is in the form of a holding apparatus, a separate holding apparatus is no longer required, which considerably reduces the complexity involved in the production of the lamp since it is possible to dispense with component parts and therefore also process steps.

It is particularly advantageous if the preferably cylindrical bulb is connected, preferably fused, to the outer bulb. By virtue of the two bulbs being connected to one another, simple handling is made possible during production. Fusing provides a particularly simple way of producing a connection between the components since it is a simple process which is in widespread use in lamp production.

It is expedient if the preferably cylindrical bulb has at least one cutout for accommodating the integral lamp. Such a cutout, for example an opening or a depression, is very suitable for fixing the integral lamp, at least with respect to movements in the radial direction.

In this case it is advantageous if the cutout for accommodating the integral lamp has approximately the contour of the cross-sectional area of the base of the integral lamp. As a result, no additional holding aids are required for precisely positioning the integral lamp.

In an expedient development of the invention, it is advantageous if the cross-sectional area of the cutout for accommodating the integral lamp has an at least approximately rectangular contour. The bases of integral lamps often have a rectangular outer contour, for example with a cross section which is rectangular or in the form of a double T. These bases can be held particularly well in a cutout with a rectangular contour.

In an expedient development of the invention, the cutout is in the form of a slit with two parallel side faces. Bases of typical integral lamps usually have at least two faces which are planar-parallel in the axial direction and which can be passed or held particularly well in such a slit, for example a rectangular slit, in particular if the latter is oriented with the longitudinal axis in the axial direction. This applies in particular to bases with a cross section which is rectangular or in the form of a double T.

It is furthermore advantageous if the integral lamp has a base with a cross section in the form of a double T, and in each case at least one outer edge of a cylinder segment, which adjoins at least one slit, of the cylindrical bulb bears against at least two flanges of the base on the inside of the flange. As a result, guidance in the radial direction parallel to the web of the base in the form of a double T can be realized in a simple manner.

In an expedient development of the invention, the preferably cylindrical bulb has an upper region with a rectangular outer contour. A rectangular region of the bulb is particularly suitable as a holder primarily for the usually likewise approximately rectangular bases of the integral lamps since then a rectangular cutout can be positioned there, around which cutout the same wall thickness can be selected on all sides.

It is advantageous if at least one spring element is arranged between the preferably cylindrical bulb and the integral lamp. Spring elements are particularly well suited for transmitting forces between brittle materials, such as glasses which are usually used for lamp production, for example, and for compensating for dimensional tolerances. A spring element which is arranged between the bulb and the integral lamp can have a very simple configuration since it only needs to transmit forces linearly and there are no guide forces which need to be transmitted.

It is likewise advantageous if at least one power supply line of the integral lamp is in the form of a spring element. The power supply lines of the integral lamp are provided in any case and usually have the required elastic properties to be used as the spring element. As a result of simple bending processes, these wires can be shaped in such a way that they act as a spring element.

It is furthermore expedient if at least one power supply wire, which leads from the base to the integral lamp, is connected to at least one power supply line of the integral lamp by a welded joint. As a result, a connection is produced using simple means which can safely and reliably transmit both mechanical forces and electrical current.

### BRIEF DESCRIPTION OF THE DRAWINGS

The invention will be explained below with reference to four exemplary embodiments. Identical and functionally identical component parts are identified by the same reference numerals. In order to illustrate the contours, glass component parts are usually illustrated as being opaque. In the figures:

FIG. 1 shows a first exemplary embodiment of a lamp according to the invention in a perspective view,

FIG. 2 shows a lamp according to the invention in accordance with the first exemplary embodiment in a perspective detail illustration,

FIG. 3 shows a lamp according to the invention in accordance with the second exemplary embodiment in a perspective detail illustration,

FIG. 4 shows a detail view of a lamp according to the invention in accordance with the second exemplary embodiment in a perspective sectional illustration.

### PREFERRED EMBODIMENT OF THE INVENTION

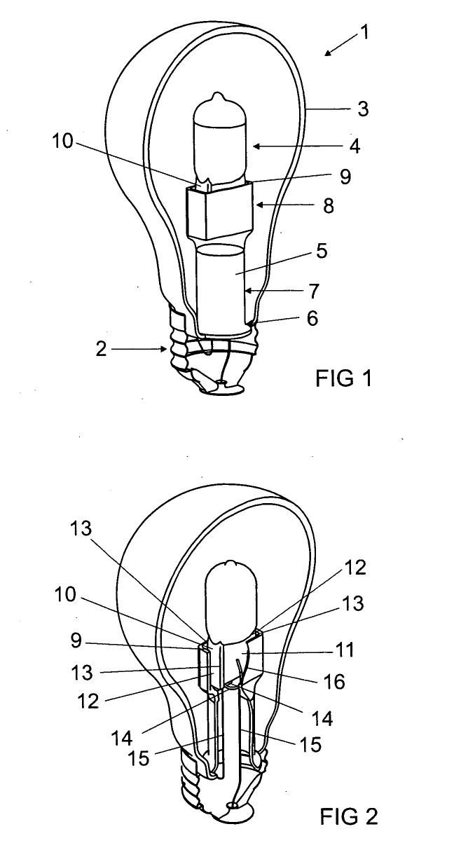

FIG. 1 shows a lamp 1 according to the invention in a perspective illustration. An outer bulb 3 of the type A55 is held in a base 2 of the conventional type E27. An integral lamp 4 is arranged within the outer bulb 3 in such a way that an incandescent wire (not illustrated here) of the integral lamp 4 is located approximately at the point within the outer bulb 3 at which the incandescent wire is likewise arranged in a conventional incandescent lamp. The integral lamp 4 is configured as a high-voltage halogen lamp and is known as such from the prior art.

The integral lamp is held in a cylindrical bulb 5, which is widened in a lower region 6 and is fused to the outer bulb 3. This allows for a likewise simple and safe connection between the two bulbs 3, 5, which are both manufactured from the same material, in the present exemplary embodiment a soft glass which is conventional in lamp construction.

While the lower region 6 and the central region 7 of the bulb 5 have a cylindrical shape, the upper region 8 is widened in the form of a rectangle. As a result, a rectangular opening 9 is provided there, in which the base 10 of the integral lamp 4 is held. Such a cylindrical bulb 5 can be produced in a simple manner by virtue of the rectangular upper region 8 being produced by means of a suitable two-fold pinch-sealing process in the case of a cylindrical glass tube.

The cylindrical bulb 5 is also illustrated in partially cut-away form in FIG. 2 in order to further show the design. The base 10 of the integral lamp 4 has a cross section in the form of a double T, with a web 11 being arranged between two flanges 12. The dimensions of the rectangular opening 9 in this case approximately correspond to the outer dimensions of the base 10 of the integral lamp 4, i.e. to the distances between the outer edges 13 of the flange 10. The integral lamp 4 is electrically connected to power supply wires 15 via power supply lines 14. The power supply lines 14 of the integral lamp 4 are bent back laterally and at the top. As a result, the power supply lines 14 act as a spring element between the bulb wall 16 and the base 10 of the integral lamp 4 and can compensate for dimensional inaccuracies of the base 10 or the cylindrical bulb 5. The contact from glass to glass can thereby be reduced or avoided in the same way as the noise which otherwise results as a result of unavoidable dimensional tolerances if the base 10 of the integral lamp 4 hits the bulb wall 16 in the event of vibrations of the lamp 1. In addition, as a result of the inclined position of the power supply lines 14 or the power supply wires 15, which are fixed thereto, the insertion of the integral lamp 4 into the cylindrical bulb 5 is facilitated. The clamping effect of the power supply lines 14 in addition acts as an additional way of safeguarding against displacement of the integral lamp 4 in the cylindrical bulb 5. As a result, in particular the holding forces in the axial direction, which are transmitted from the power supply lines 14 to the power supply wires 15, which lead from the base 2 of the lamp 1 to the integral lamp 4, are reduced.

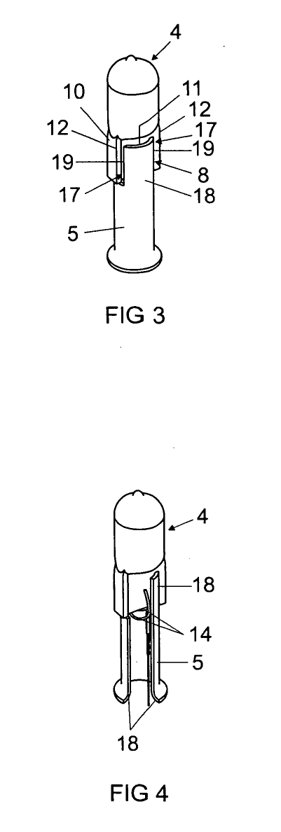

FIG. 3 shows a further exemplary embodiment of the invention. For reasons of clarity, the outer bulb 3 and the base 2 of the lamp 1 have not been illustrated here, and only the cylindrical bulb 5 and the integral lamp 4 are shown.

In the upper region 8, the cylindrical bulb 5 has two rectangular slits 17, in which the base 10 of the integral lamp 4 is held. The slits 17 are arranged on opposite sides of the bulb 5, with the result that their width and therefore the distance between two identical, mutually opposite cylinder segments 18 corresponds to the thickness of the web 11 of the base 10 of the integral lamp 4. The diameter of the cylindrical bulb 5 is selected in such a way that the distance between the edges 19 of a cylinder segment 18 corresponds to the width of the web 11, with the result that the integral lamp 4 with the flanges 12 is guided laterally on the edges 19 of the cylinder segments 18.

The length of the slits 17 corresponds to the length of the base 10 of the integral lamp 4, which allows for a bearing face between the cylindrical bulb 5 and the base 10 of the integral lamp 4 which is as large as possible, as a result of which loading at certain points on the components is avoided.

The slits 17 can be introduced in a very precise manner into the cylindrical bulb 5 by means of conventional methods, such as sawing, grinding or laser cutting. Pinch-sealing processes, as are required in the first exemplary embodiment for producing the rectangular opening 9 in the upper region 8, can be dispensed with.

As can be seen from FIG. 4, in which the cylindrical bulb 5 is shown in partially cut-away form, in this embodiment too the power supply lines 14 of the integral lamp 4 are bent back laterally and at the top. They therefore act as a spring element on the cylinder segments 18 and fix the integral lamp 4 in a reliable manner. In the axial direction, the integral lamp 4 is secured in this embodiment too by the power supply wires 15, which are welded to the power supply lines 14.

Other configurations of the invention are naturally also conceivable, in particular for achieving a way of holding the integral lamp 4 as effectively as possible in the case of a base shape which is different from that shown. In both embodiments variants are therefore conceivable in which independent spring elements, for example in the form of bent sheet-metal platelets, are positioned between the base 10 and the cylinder segments 18 or the bulb wall 16.

In order to facilitate the insertion of the integral lamp 4 into the cylindrical bulb 5, in addition the upper edges of the cylindrical bulb 5 can be beveled.

For the two power supply wires 15, the metals or metal alloys which are conventionally used for this purpose are used, for example copper, copper/nickel alloys, spring steel wires, in particular of the chromium/nickel type or further alloys based on iron. Likewise, the sorts of glass conventionally used in lamp construction can likewise be used for the glass components.

Instead of the outer bulb 3, which is shown in the exemplary embodiments and is typical of a general-service incandescent lamp, with the designation A55, other bulb shapes, such as the types A60, R63, R80 or G95, for example, are naturally also conceivable, and other base sizes, such as E14 or E40 and other base types, such as a bayonet-type base or a plug-type base, for example, are also possible instead of the screw-type base 2 shown of the type E27.

During fitting of the lamp 1, first the power supply lines 14 of the integral lamp 4 are bent into the appropriate shape and are then welded to the power supply wires 15. A bending operation can possibly also follow, in which the power supply lines 14 obtain their final shape. Then, the power supply wires 15 are inserted into the cylindrical bulb 5 and the outer bulb 3 is turned over said cylindrical bulb 5 and fused to the cylindrical bulb 5. Finally, the base 2 provided with cement is pushed over the outer bulb 3, the cement is baked, and the power supply wires 15 are brought to size and connected to the base 2 by means of soldering.

1. An electric lamp (1) with a base at one end and with an outer bulb (3), mounted in a base (2), and at least one integral lamp (4), preferably a high-voltage halogen lamp, which is arranged within the outer bulb (3), and at least two power supply wires (15) from the base (2) to the integral lamp (4), characterized in that the at least two power supply wires (15) are surrounded by a preferably cylindrical bulb (5), formed from a nonconductive light-permeable material, preferably identical to the material used for the outer bulb (3), in particular glass, and the preferably cylindrical bulb (5) is in the form of a holding apparatus for the integral lamp (4).

2. The electric lamp (1) with a base at one end as claimed in claim 1, characterized in that the preferably cylindrical bulb (5) is connected, preferably fused, to the outer bulb (3).

3. The electric lamp (1) with a base at one end as claimed in claim 1, characterized in that the preferably cylindrical bulb has at least one cutout (9, 17) for accommodating the integral lamp (4).

4. The electric lamp (1) with a base at one end as claimed in claim 1, characterized in that the cutout (9) for accommodating the integral lamp (4) has approximately the contour of the cross-sectional area of the base (10) of the integral lamp (4).

5. The electric lamp (1) with a base at one end as claimed in claim 1, characterized in that the cross-sectional area of the cutout (9, 17) for accommodating the integral lamp (4) has an at least approximately rectangular contour.

6. The electric lamp (1) with a base at one end as claimed in claim 1, characterized in that the cutout (17) is in the form of a slit (17) with two parallel side faces (19).

7. The electric lamp (1) with a base at one end as claimed in claim 1, characterized in that the integral lamp (4) has a base (10) with a cross section in the form of a double T, and in each case at least one outer edge (19) of a cylinder segment (18), which adjoins at least one slit (17), of the cylindrical bulb (5) bears against at least two flanges (12) of the base (10) on the inside of the flange (12).

8. The electric lamp (1) with a base at one end as claimed in claim 1, characterized in that the preferably cylindrical bulb (5) has an upper region (8) with a rectangular outer contour.

9. The electric lamp (1) with a base at one end as claimed in claim 1, characterized in that at least one spring element (14) is arranged between the preferably cylindrical bulb (5) and the integral lamp (4).

10. The electric lamp (1) with a base at one end as claimed in claim 1, characterized in that at least one power supply line (14) of the integral lamp (4) is in the form of a spring element (14).

11. The electric lamp (1) with a base at one end as claimed in claim 1, characterized in that at least one power supply wire (15), which leads from the base (2) to the integral lamp (4), is connected to at least one power supply line (14) of the integral lamp (4) by a welded joint.

12. The electric lamp (1) with a base at one end as claimed in claim 2, characterized in that the preferably cylindrical bulb has at least one cutout (9, 17) for accommodating the integral lamp (4).

13. The electric lamp (1) with a base at one end as claimed in claim 2, characterized in that the cutout (9) for accommodating the integral lamp (4) has approximately the contour of the cross-sectional area of the base (10) of the integral lamp (4).

14. The electric lamp (1) with a base at one end as claimed in claim 2, characterized in that the cross-sectional area of the cutout (9, 17) for accommodating the integral lamp (4) has an at least approximately rectangular contour.

15. The electric lamp (1) with a base at one end as claimed in claim 2, characterized in that the cutout (17) is in the form of a slit (17) with two parallel side faces (19).

16. The electric lamp (1) with a base at one end as claimed in claim 2, characterized in that the integral lamp (4) has a base (10) with a cross section in the form of a double T, and in each case at least one outer edge (19) of a cylinder segment (18), which adjoins at least one slit (17), of the cylindrical bulb (5) bears against at least two flanges (12) of the base (10) on the inside of the flange (12).

17. The electric lamp (1) with a base at one end as claimed in claim 2, characterized in that the preferably cylindrical bulb (5) has an upper region (8) with a rectangular outer contour.

18. The electric lamp (1) with a base at one end as claimed in claim 2, characterized in that at least one spring element (14) is arranged between the preferably cylindrical bulb (5) and the integral lamp (4).

19. The electric lamp (1) with a base at one end as claimed in claim 2, characterized in that at least one power supply line (14) of the integral lamp (4) is in the form of a spring element (14).

20. The electric lamp (1) with a base at one end as claimed in claim 2, characterized in that at least one power supply wire (15), which leads from the base (2) to the integral lamp (4), is connected to at least one power supply line (14) of the integral lamp (4) by a welded joint.
